(19) United States
(12) Patent Application Publication
(10) Pub. No.: US 2003/0160430 A1
(43) Pub. Date: Aug. 28, 2003

(54) Vehicle integrated hitch and bumper support assembly and method for making same

(75) Inventors: David L. Westerdale, Monroe, MI (US); William J. Boberg, Monroe, MI (US)

Correspondence Address: BROOKS & KUSHMAN, 1000 TOWN CENTER 22ND FL, SOUTHFIELD, MI, 48075

(73) Assignee: Midway Products Group, Inc., Monroe, MI

(21) Appl. No.: 10/082,573

(22) Filed: Feb. 25, 2002

(51) Int. Cl. B60D 1/00

(52) U.S. Cl. 280/495

(57) ABSTRACT

A vehicle integrated hitch and bumper support assembly (10) and a method for making the support assembly from tube stock includes an elongated tube (12) having an intermediate portion (14) and end portions (16) that are cut so that the elongated tubes can be cut from tube stock whose length is less than the combined length of the elongated tubes.

### BACKGROUND OF THE INVENTION

1. Field of the Invention

This invention relates to an integrated hitch and bumper support assembly for mounting a vehicle hitch and bumper and also relates to a method for making the support assembly.

2. Background Art

The conventional construction for mounting a vehicle hitch and bumper on a vehicle rear end utilizes a tubular support that extends laterally with respect to the vehicle and has an enclosed cross section along its entire length. Opposite distal ends of the tubular support have bumper end mounts for supporting the opposite lateral ends of the bumper, while an intermediate portion of the tubular support is mounted by the vehicle frame. A hitch receiver tube of the hitch and bumper support assembly is mounted centrally on the tubular support between its opposite distal ends to receive a hitch. The opposite lateral bumper ends also have previously been mounted by separately fabricated tubular extensions that extend laterally outboard from the closed cross section of the tubular support.

Vehicle hitch and bumper supports generally as described above are disclosed by U.S. Pat. No. 4,738,464 Putnam; U.S. Pat. No. 5,094,469 Yamamoto et al.; U.S. Pat. No. 5,489,111 Collins; U.S. Pat. No. 5,628,536 Fulkerson; and U.S. Pat. No. 6,139,044 Smith et al.

### SUMMARY OF THE INVENTION

An object of the present invention is to provide an improved integrated hitch and bumper support assembly for use with a vehicle.

In carrying out the above object, the improved vehicle integrated hitch and bumper support assembly includes an elongated tube having an intermediate portion and a pair of opposite end portions between which the intermediate portion extends. The intermediate portion of the elongated tube has a cross section of a closed shape. A hitch receiver tube of the support assembly is secured to the intermediate portion of the elongated tube centrally between the pair of opposite end portions to receive a hitch to be utilized with the support assembly. The pair of opposite end portions of the elongated tube each have a cross section of a vertically opening shape that permits a plurality of the elongated tubes to be cut from elongated tube stock whose length is less than the combined length of the elongated tubes. A pair of bumper end mounts are respectively supported on the pair of end portions of the elongated tube to provide support for ends of an associated bumper.

The manner in which the pair of end portions of the elongated tube open vertically and permit a plurality of the elongated tubes to be cut from a shorter length of tube stock than the combined length of the elongated tubes provides a lightweight construction as well as reducing the cost of the fabricated support assembly.

In the disclosed construction, the intermediate portion of the elongated tube has upward bends such that the pair of end portions are inclined upwardly in a direction extending away from each other. A pair of bumper intermediate mounts are also disclosed as being adapted to be mounted on the associated vehicle frame to support intermediate portions of the associated bumper.

In the preferred construction disclosed, the pair of end portions of the elongated tube each have a downwardly opening shape. The pair of bumper end mounts are disclosed as being fabricated separately from the elongated tube and are respectively supported and secured to distal ends of the pair of end portions.

The intermediate portion of the elongated tube is disclosed in one construction as having a square cross section and in another construction as having a round cross section. Furthermore, the intermediate portion of the elongated tube is disclosed as having a length that is greater than the combined length of the pair of end portions.

Another object of the present invention is to provide an improved method for making integrated hitch and bumper support assemblies for use with vehicles.

In carrying out the above object, the improved method for making vehicle integrated hitch and bumper support assemblies is performed by providing metallic elongated tube stock having a central axis and a closed cross section transverse to the central axis along the length of the tube stock. The elongated tube stock is cut at spaced locations to provide elongated tubes that each have an intermediate portion and a pair of end portions between which the intermediate portion extends. The cutting is performed to provide shapes that permit a plurality of the elongated tubes to be cut with a combined length that is greater than the length of the elongated tube stock used. A hitch receiver tube is secured to the intermediate portion of the elongated tube, and the pair of end portions of each cut elongated tube are provided with a pair of bumper end mounts for mounting ends of an associated bumper.

As disclosed, each elongated tube is bent at spaced locations after being cut from the elongated tube stock. Likewise, the hitch receiver tube is secured to the intermediate portion of the associated elongated tube after the elongated tube is cut from the elongated tube stock.

The method for making the support assembly is also performed by fabricating the pair of bumper end mounts separately from the elongated tube stock and by supporting and securing the bumper end mounts to distal ends of the end portions of the associated elongated tube after the cutting thereof from the elongated tube stock.

The objects, features and advantages of the present invention are readily apparent from the following detailed description of the invention when taken in connection with the accompanying drawings.

### BRIEF DESCRIPTION OF THE DRAWINGS

FIG. 1 is a top plan view of a vehicle integrated hitch and bumper support assembly constructed in accordance with the invention.

FIG. 2 is a rear elevational view of the bumper support assembly taken along the direction line 2-2 in FIG. 1.

FIG. 3 is a side view of the support assembly taken along the direction of line 3-3 in FIG. 2.

FIG. 4 is a cross sectional view taken along the direction of line 4-4 in FIG. 1 through an intermediate portion of the elongated tube of the support assembly.

FIG. 5 is a cross sectional view taken along the direction of line 5-5 of one of the end portions of the elongated tube to illustrate the manner in which the end portion opens vertically.

FIGS. 6 and 7 are respectively cross sectional views of the intermediate and end portions of another embodiment of the elongated tube which has a round shape as opposed to the square shape illustrated in the embodiment of FIGS. 4 and 5.

FIG. 8 is a view that illustrates the manner in which the elongated tube is cut from tube stock to provide a plurality of elongated tubes of a lightweight construction that utilizes less tube stock than the combined lengths of the elongated tubes cut from the tube stock.

FIG. 9 is a view that illustrates the manner in which the cut elongated tube is bent to provide end portions that extend upwardly away from each other.

### DETAILED DESCRIPTION OF THE PREFERRED EMBODIMENTS

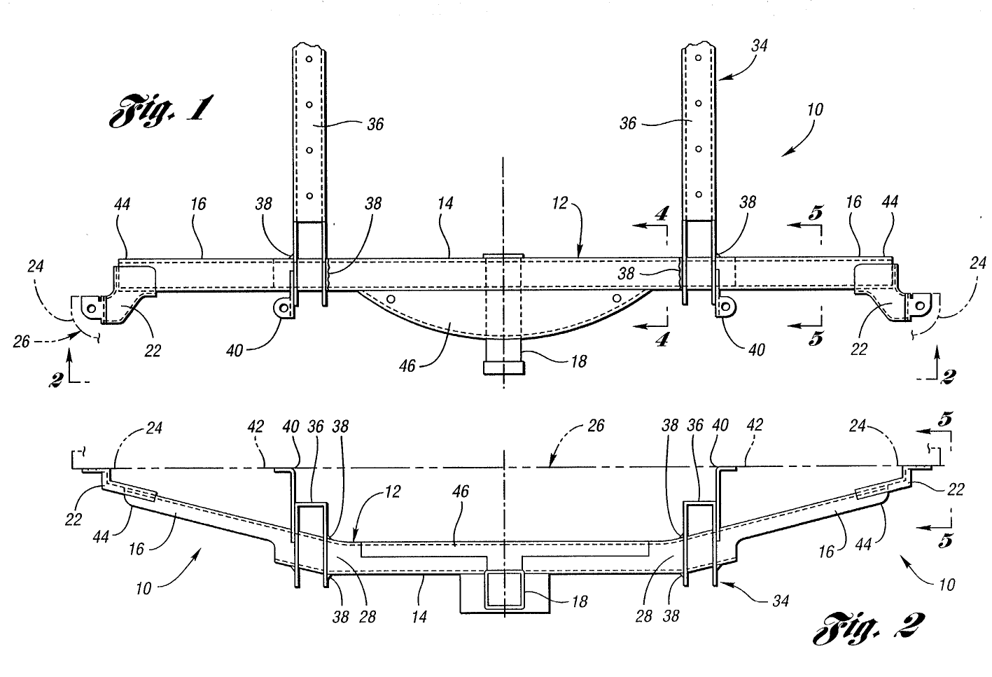

With reference to FIGS. 1-3, a vehicle integrated hitch and bumper support assembly generally indicated by 10 is constructed in accordance with the present invention and made in accordance with the method thereof. Both the construction of the support assembly 10 and the method for making the support assembly will be described in an integrated manner to facilitate an understanding of all aspects of the invention.

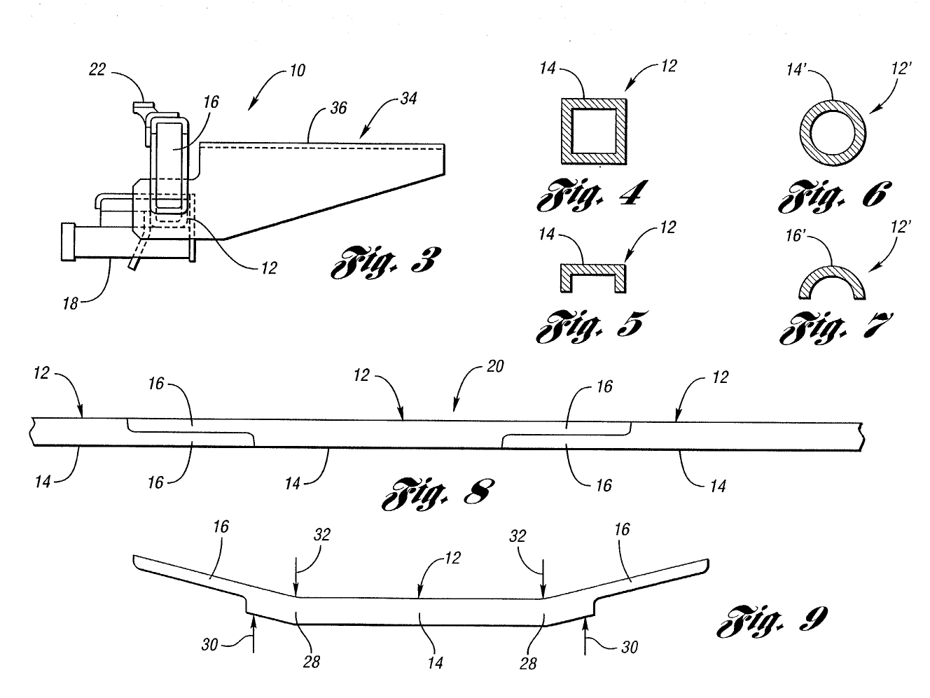

With continuing reference to FIGS. 1-3, the vehicle integrated hitch and bumper support assembly 10 is disclosed as including an elongated tube 12 of a unitary construction having an intermediate portion 14 and a pair of opposite end portions 16 between which the intermediate portion extends. The intermediate portion 14 of the elongated tube has a closed shape which may be either square as illustrated in FIG. 4 or may be round as illustrated by the alternate embodiment illustrated in FIG. 6 with prime reference numerals. A hitch receiver tube 18 is secured to the intermediate portion 14 of the elongated tube 12 centrally between the pair of opposite end portions 16 to receive a hitch to be utilized therewith in towing of a trailer behind the vehicle. The pair of opposite end portions 16 of the elongated tube 12 each have a cross section of a vertically opening shape which, as illustrated in FIG. 5 can be squared or rounded as illustrated by the primed reference numerals in FIG. 7. Whether the end portions 16 of the elongated tube are squared or rounded, they are cut as illustrated in FIG. 8 from elongated tube stock 20 whose length is less than the combined length of the cut elongated tubes. More specifically, the end portions 16 overlap each other so as to reduce cost as well as the weight of the fabricated support assembly. A pair of bumper end mounts 22 are respectively supported by the pair of end portions 16 as shown in FIGS. 1 and 2 to provide support for ends 24 of an associated bumper 26.

While it is possible to cut the tube ends 16 in different ways, laser cutting permits the elongated tube fabrication to be done with minimal material loss in a time efficient manner. As illustrated in FIG. 8, the end portions 16 have generally the same vertical height as each other although it is also possible for the end portions to have their heights tapering from a greater height to a lesser height in an outboard direction while still having the overlapping construction of the end portions that provides the lightweight and cost advantage associated with utilizing a lesser amount of tube stock as described above.

As illustrated in FIG. 9, the intermediate portion 14 of the elongated tube 12 have bends 28 that are provided by force supplied in opposite directions as illustrated by arrows 30 and 32. These bends 28 provide the elongated tube 12 with its end portions 16 extending upwardly in a direction away from each other, which is a construction that facilities the proper positioning of both the mounted hitch receiver tube and bumper end mounts described above.

As illustrated in FIGS. 1-3, the associated vehicle with which the support assembly 10 is utilized has a frame 34 including a pair of laterally spaced frame members 36 on which the elongated tube 12 is mounted and secured by welds 38. A pair of bumper intermediate mounts 40 of the support assembly are adapted to be mounted on the associated vehicle frame 34 by its frame members 36 and secured by suitable welding to support intermediate portions 42 of the associated bumper 26 as best illustrated in FIG. 2.

It is preferably for the bumper end mounts 22 illustrated in FIGS. 1 and 2 to be fabricated separately from the elongated tube 12, although it is also possible for the bumper end mounts to be unitary with the elongated tube. Furthermore, these bumper end mounts 22 are preferably supported and secured to distal ends 44 of the end portions 16 after the elongated tubes are cut from each other from the tube stock as previously described. In addition, the intermediate portion 14 of each elongated tube 12 has a length that is greater than the combined length of the pair of end portions 16. Likewise, the hitch receiver tube 18 is secured to the intermediate portion 14 of the elongated tube after the elongated tube is cut from the elongated tube stock.

More specifically, the hitch receiver tube 18 illustrated in FIGS. 1-3 is secured to the intermediate portion 14 of the elongated tube 12 by suitable welding after the elongated tube is cut from the tube stock. Furthermore, a step plate 46 is welded to the intermediate tube portion 14 and to the receiver tube 18 and will normally be covered by a portion of the bumper cover which is conventionally constructed as a plastic covering over the bumper and the support assembly.

While the best modes for practicing the invention have been described in detail, those familiar with the art to which this invention relates will recognize various alternative designs and embodiments for practicing the invention as defined by the following claims.

What is claimed is:

1. A vehicle integrated hitch and bumper support assembly comprising:
an elongated tube including an intermediate portion and a pair of opposite end portions between which the intermediate portion extends;
the intermediate portion of the elongated tube having a cross section of a closed shape;
a hitch receiver tube secured to the intermediate portion of the elongated tube centrally between the pair of opposite end portions to receive a hitch to be utilized therewith;
the pair of opposite end portions of the elongated tube each having a cross section of a vertically opening shape that permits a plurality of the elongated tubes to be cut from elongated tube stock whose length is less than the combined length of the cut elongated tubes; and
a pair of bumper end mounts respectively supported on the pair of end portions of the elongated tube to provide support for ends of an associated bumper.

2. A vehicle integrated hitch and bumper support assembly as in claim 1 wherein the intermediate portion of the elongated tube has upward bends such that the pair of end portions are inclined upwardly in a direction extending away from each other.

3. A vehicle integrated hitch and bumper support assembly as in claim 2 further including a pair of bumper intermediate mounts adapted to be mounted on an associated vehicle frame to support intermediate portions of the associated bumper.

4. A vehicle integrated hitch and bumper support assembly as in claim 1 wherein the pair of end portions of the elongated tube each have a downwardly opening shape.

5. A vehicle integrated hitch and bumper support assembly as in claim 1 wherein the pair of bumper end mounts are fabricated separately from the elongated tube and are respectively supported and secured to distal ends of the pair of end portions of the elongated tube.

6. A vehicle integrated hitch and bumper support assembly as in claim 1 wherein the intermediate portion of the elongated tube has a square cross section.

7. A vehicle integrated hitch and bumper support assembly as in claim 1 wherein the intermediate portion of the elongated tube has a round cross section.

8. A vehicle integrated hitch and bumper support assembly as in claim 1 wherein the intermediate portion of the elongated tube has a length that is greater than the combined length of the pair of end portions.

9. A vehicle integrated hitch and bumper support assembly comprising:
an elongated tube including an intermediate portion and a pair of opposite end portions between which the intermediate portion extends;
the intermediate portion of the elongated tube having a closed cross section;
a hitch receiver tube secured to the intermediate portion of the elongated tube centrally between the pair of opposite end portions to receive a hitch to be utilized therewith;
the pair of opposite end portions of the elongated tube each having a downwardly opening cross section that permits a plurality of the elongated tubes to be cut from elongated tube stock whose length is less than the combined length of the cut elongated tubes; and
a pair of bumper end mounts respectively supported on the pair of end portions of the elongated tube to provide support for ends of an associated bumper.

10. A vehicle integrated hitch and bumper support assembly comprising:
an elongated tube including an intermediate portion and a pair of opposite end portions between which the intermediate portion extends;
the intermediate portion of the elongated tube having a closed cross section and also having a pair of upward bends;
a hitch receiver tube secured to the intermediate portion of the elongated tube centrally between the pair of opposite end portions to receive a hitch to be utilized therewith;
the pair of opposite end portions of the elongated tube being inclined upwardly in a direction away from each other and each having a downwardly opening cross section that permits a plurality of the elongated tubes to be cut from elongated tube stock whose length is less than the combined length of the cut elongated tubes;
a pair of bumper end mounts fabricated separately from the elongated tube and respectively supported and secured on distal ends of the pair of end portions of the elongated tube to provide support for ends of an associated bumper; and
a pair of bumper intermediate mounts adapted to be mounted on an associated vehicle frame to support intermediate portions of the associated bumper.

11. A method for making vehicle integrated hitch and bumper support assemblies comprising:
providing metallic elongated tube stock having a central axis and a closed cross section transverse to the central axis along the length of the tube stock;
cutting the elongated tube stock at spaced locations to provide elongated tubes that each have an intermediate portion and a pair of end portions between which the intermediate portion extends, and with the cutting being in shapes that permit a plurality of the elongated tubes to be cut with a combined length that is greater than the length of the elongated tube stock that is used;
securing a hitch receiver tube to the intermediate portion of each elongated tube; and
providing the pair of end portions of each cut elongated tube with a pair of bumper end mounts for mounting the ends of an associate vehicle bumper.

12. A method for making vehicle integrated hitch and bumper support assemblies as in claim 11 wherein each elongated tube is bent at spaced locations after being cut from the elongated tube stock.

13. A method for making vehicle integrated hitch and bumper support assemblies as in claim 11 wherein hitch receiver tube is secured to the intermediate portion of the associated elongated tube after the elongated tube is cut from the elongated tube stock.

14. A method for making vehicle integrated hitch and bumper support assemblies as in claim 11 wherein the pairs of bumper end mounts are fabricated separately from the elongated tube stock and are supported and secured to distal ends of the end portions of the associated elongated tube after the cutting thereof from the elongated tube stock.

15. A method for making vehicle integrated hitch and bumper support assemblies comprising:
providing metallic elongated tube stock having a central axis and a closed cross section transverse to the central axis along the length of the tube stock;
cutting the elongated tube stock at spaced locations to provide elongated tubes that each have an intermediate portion and a pair of end portions between which the intermediate portion extends, and with the cutting being in shapes that permit a plurality of the elongated tubes to be cut with a combined length that is greater than the length of the elongated tube stock that is used;
securing a hitch receiver tube to the intermediate portion of each elongated tube after cutting thereof from the elongated tube stock;
fabricating a pair of bumper end mounts separately from the elongated tube stock and respectively supporting and securing the pair of bumper end mounts to a pair of distal ends of the pair of end portions of an associated elongated tube after cutting thereof from the elongated tube stock.
